(19) United States
(12) Patent Application Publication
(10) Pub. No.: US 2008/0234928 A1
(43) Pub. Date: Sep. 25, 2008

(54) Location based services using altitude

(75) Inventor: Yoshimichi Matsuoka, Cupertino, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 11/728,260

(22) Filed: Mar. 23, 2007

(51) Int. Cl. G01C 21/00

(52) U.S. Cl. 701/204; 701/206; 701/207; 701/213

(57) ABSTRACT

A mobile computing device comprises a housing configured to be carried by a user, a position determination circuit configured to generate device position data comprising device altitude data, and a processing circuit. The processing circuit is configured to receive destination position data for a destination. The destination position data comprises destination altitude data. The processing circuit is configured to provide an indication to a user based on the device altitude data and destination altitude data

### BACKGROUND

Some mobile computing devices provide location-based services to a user. For example, a user may use a mobile computing device to report their location to a 9-1-1 emergency service in the event of an emergency. Further, the mobile computing device may use a navigation application to provide directions from the user's current location to a desired destination.

Navigation systems use latitude and longitude data from a global position system (GPS) receiver to identify the location of the system and then chart a route to a destination. The system calculates the route using latitude and longitude data from a geographic information system (GIS) database.

There is a need for a system and method for providing location based systems using altitude data. Further, there is a need for providing a more accurate measurement of distance and/or travel time between a current position and a destination or waypoint. There is also a need for providing directions to a particular floor of a building. There is also a need for distinguishing whether a vehicle is on an upper or lower roadway of a layered roadway.

The teachings herein extend to those embodiments which fall within the scope of the appended claims, regardless of whether they accomplish one or more of the above-mentioned needs.

### BRIEF DESCRIPTION OF THE DRAWINGS

FIG. 1 is a front view of a mobile computing device, according to an exemplary embodiment;

FIG. 2 is a back view of a mobile computing device, according to an exemplary embodiment;

FIG. 3 is a block diagram of the mobile computing device of FIGS. 1 and 2, according to an exemplary embodiment;

FIG. 4 is a flowchart illustrating a system and method for location based services using altitude, according to an exemplary embodiment;

FIG. 5 is a flowchart illustrating a system and method for location based services using altitude, according to an exemplary embodiment; and

FIG. 6 is a flowchart illustrating indications or output data provided to a user based on altitude data, according to an exemplary embodiment.

### DETAILED DESCRIPTION OF EXEMPLARY EMBODIMENTS

The disclosure of U.S. patent application Ser. No. 11/469,374 filed Aug. 31, 2006 is incorporated by reference herein in its entirety.

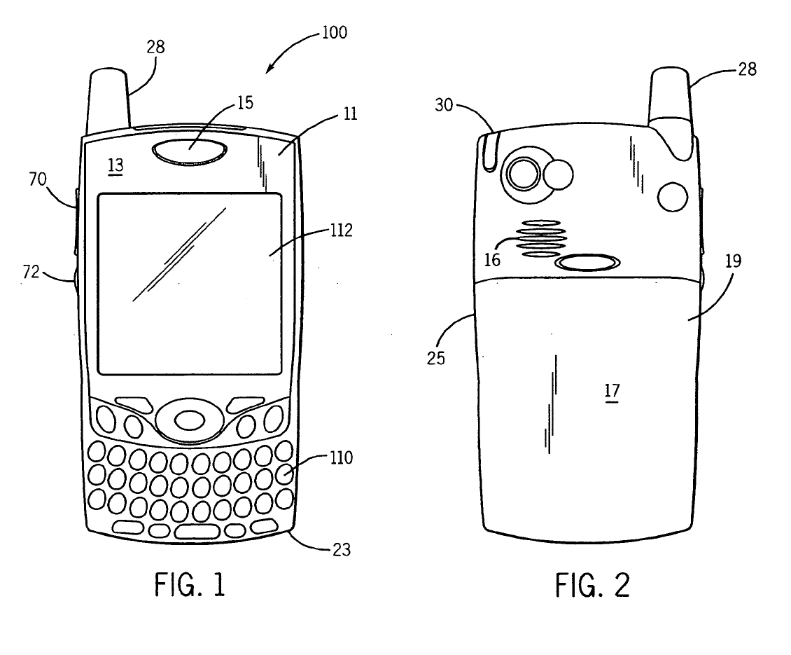

Referring first to FIG. 1, a mobile computing device 100 is shown. Device 100 is a smart phone, which is a combination mobile telephone and handheld computer having personal digital assistant functionality. The teachings herein can be applied to other mobile computing devices (e.g., a laptop computer) which are configured to be carried by a user while in use or other electronic devices (e.g., a desktop personal computer, etc.). Personal digital assistant functionality can comprise one or more of personal information management, database functions, word processing, spreadsheets, voice memo recording, etc. and is configured to synchronize personal information from one or more applications with a computer (e.g., desktop, laptop, server, etc.). Device 100 is further configured to receive and operate additional applications provided to device 100 after manufacture, e.g., via wired or wireless download, SecureDigital card, etc.

Device 100 comprises a housing 11 having a front side 13 and a back side 17 (FIG. 2). An earpiece speaker 15, a loudspeaker 16, and a user input device (e.g., a plurality of keys) are coupled to housing 11. Housing 11 is configured to hold a screen in a fixed relationship above a user input device in a substantially parallel or same plane. This fixed relationship excludes a hinged or movable relationship between the screen and plurality of keys in the fixed embodiment. Device 100 may be a handheld computer, which is a computer small enough to be carried in a typical front pocket found in a pair of pants, comprising such devices as typical mobile telephones and personal digital assistants, but excluding typical laptop computers and tablet PCs. In alternative embodiments, display 112, user input device 110, earpiece 15 and loudspeaker 16 may each be positioned anywhere on front side 13, back side 17 or the edges therebetween.

In various embodiments device 100 has a width (shorter dimension) of no more than about 200 mm or no more than about 100 mm. According to some of these embodiments, housing 11 has a width of no more than about 85 mm or no more than about 65 mm. According to some embodiments, housing 11 has a width of at least about 30 mm or at least about 50 mm. According to some of these embodiments, housing 11 has a width of at least about 55 mm.

In some embodiments, housing 11 has a length (longer dimension) of no more than about 200 mm or no more than about 150 mm. According to some of these embodiments, housing 11 has a length of no more than about 135 mm or no more than about 125 mm. According to some embodiments, housing 11 has a length of at least about 70 mm or at least about 100 mm. According to some of these embodiments, housing 11 has a length of at least about 110 mm.

In some embodiments, housing 11 has a thickness (smallest dimension) of no more than about 150 mm or no more than about 50 mm. According to some of these embodiments, housing 11 has a thickness of no more than about 30 mm or no more than about 25 mm. According to some embodiments, housing 11 has a thickness of at least about 10 mm or at least about 15 mm. According to some of these embodiments, housing 11 has a thickness of at least about 50 mm.

In some embodiments, housing 11 has a volume of up to about 2500 cubic centimeters and/or up to about 1500 cubic centimeters. In some of these embodiments, housing 11 has a volume of up to about 1000 cubic centimeters and/or up to about 600 cubic centimeters.

While described with regards to a hand-held device, many embodiments are usable with portable devices which are not handheld and/or with non-portable devices/systems.

Device 100 may provide voice communications functionality in accordance with different types of cellular radiotelephone systems. Examples of cellular radiotelephone systems may include Code Division Multiple Access (CDMA) cellular radiotelephone communication systems, Global System for Mobile Communications (GSM) cellular radiotelephone systems, etc.

In addition to voice communications functionality, device 100 may be configured to provide data communications functionality in accordance with different types of cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, etc.

Device 100 may be configured to provide voice and/or data communications functionality in accordance with different types of wireless network systems. Examples of wireless network systems may further include a wireless local area network (WLAN) system, wireless metropolitan area network (WMAN) system, wireless wide area network (WWAN) system, and so forth. Examples of suitable wireless network systems offering data communication services may include the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, a wireless personal area network (PAN) system, such as a Bluetooth system operating in accordance with the Bluetooth Special Interest Group (SIG) series of protocols.

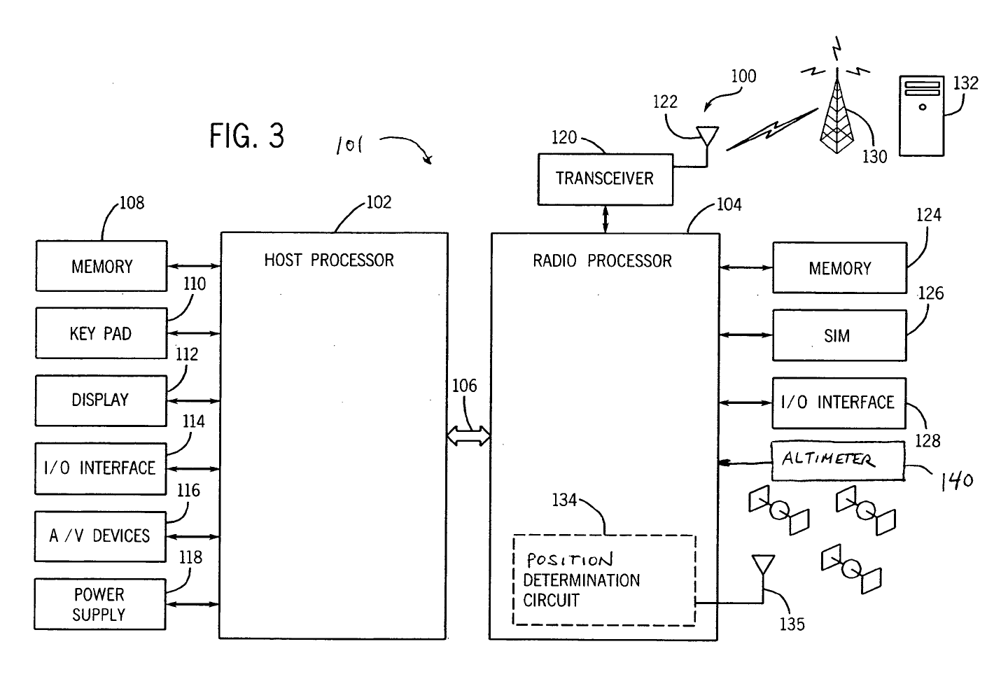

As shown in the embodiment of FIG. 3, device 100 may comprise a processing circuit 101 which may comprise a dual processor architecture including a host processor 102 and a radio processor 104 (e.g., a base band processor). The host processor 102 and the radio processor 104 may be configured to communicate with each other using interfaces 106 such as one or more universal serial bus (USB) interfaces, micro-USB interfaces, universal asynchronous receiver-transmitter (UART) interfaces, general purpose input/output (GPIO) interfaces, control/status lines, control/data lines, shared memory, and so forth.

The host processor 102 may be responsible for executing various software programs such as application programs and system programs to provide computing and processing operations for device 100. The radio processor 104 may be responsible for performing various voice and data communications operations for device 100 such as transmitting and receiving voice and data information over one or more wireless communications channels. Although embodiments of the dual processor architecture may be described as comprising the host processor 102 and the radio processor 104 for purposes of illustration, the dual processor architecture of device 100 may comprise additional processors, may be implemented as a dual- or multi-core chip with both host processor 102 and radio processor 104 on a single chip, etc. Alternatively, processing circuit 101 may comprise any digital and/or analog circuit elements, comprising discrete and/or solid state components, suitable for use with the embodiments disclosed herein.

In various embodiments, the host processor 102 may be implemented as a host central processing unit (CPU) using any suitable processor or logic device, such as a general purpose processor. The host processor 102 may comprise, or be implemented as, a chip multiprocessor (CMP), dedicated processor, embedded processor, media processor, input/output (I/O) processor, co-processor, a field programmable gate array (FPGA), a programmable logic device (PLD), or other processing device in alternative embodiments.

The host processor 102 may be configured to provide processing or computing resources to device 100. For example, the host processor 102 may be responsible for executing various software programs such as application programs and system programs to provide computing and processing operations for device 100. Examples of application programs may include, for example, a telephone application, voicemail application, e-mail application, instant message (IM) application, short message service (SMS) application, multimedia message service (MMS) application, web browser application, personal information manager (PIM) application, contact management application, calendar application, scheduling application, task management application, word processing application, spreadsheet application, database application, video player application, audio player application, multimedia player application, digital camera application, video camera application, media management application, a gaming application, and so forth. The application software may provide a graphical user interface (GUI) to communicate information between device 100 and a user.

System programs assist in the running of a computer system. System programs may be directly responsible for controlling, integrating, and managing the individual hardware components of the computer system. Examples of system programs may include, for example, an operating system (OS), device drivers, programming tools, utility programs, software libraries, an application programming interface (API), graphical user interface (GUI), and so forth. Device 100 may utilize any suitable OS in accordance with the described embodiments such as a Palm OS®, Palm OS® Cobalt, Microsoft® Windows OS, Microsoft Windows® CE, Microsoft Pocket PC, Microsoft Mobile, Symbian OS™, Embedix OS, Linux, Binary Run-time Environment for Wireless (BREW) OS, JavaOS, a Wireless Application Protocol (WAP) OS, and so forth.

Device 100 may comprise a memory 108 coupled to the host processor 102. In various embodiments, the memory 108 may be configured to store one or more software programs to be executed by the host processor 102. The memory 108 may be implemented using any machine-readable or computer-readable media capable of storing data such as volatile memory or non-volatile memory, removable or non-removable memory, erasable or non-erasable memory, writeable or re-writeable memory, and so forth. Examples of machine-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), or any other type of media suitable for storing information.

Although the memory 108 may be shown as being separate from the host processor 102 for purposes of illustration, in various embodiments some portion or the entire memory 108 may be included on the same integrated circuit as the host processor 102. Alternatively, some portion or the entire memory 108 may be disposed on an integrated circuit or other medium (e.g., hard disk drive) external to the integrated circuit of host processor 102. In various embodiments, device 100 may comprise an expansion slot to support a multimedia and/or memory card, for example.

Device 100 may comprise a user input device 110 coupled to the host processor 102. The user input device 110 may comprise, for example, a QWERTY key layout and an integrated number dial pad. Device 100 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, a keypad, an alphanumeric keypad, and so forth.

The host processor 102 may be coupled to a display 112. The display 112 may comprise any suitable visual interface for displaying content to a user of device 100. For example, the display 112 may be implemented by a liquid crystal display (LCD) such as a touch-sensitive color (e.g., 16-bit color) thin-film transistor (TFT) LCD screen. In some embodiments, the touch-sensitive LCD may be used with a stylus and/or a handwriting recognizer program.

Device 100 may comprise an input/output (I/O) interface 114 coupled to the host processor 102. The I/O interface 114 may comprise one or more I/O devices such as a serial connection port, an infrared port, integrated Bluetooth® wireless capability, and/or integrated 802.11x (WiFi) wireless capability, to enable wired (e.g., USB cable) and/or wireless connection to a local computer system, such as a local personal computer (PC). In various implementations, device 100 may be configured to transfer and/or synchronize information with the local computer system.

The host processor 102 may be coupled to various audio/video (A/V) devices 116 that support A/V capability of device 100. Examples of A/V devices 116 may include, for example, a microphone, one or more speakers, an audio port to connect an audio headset, an audio coder/decoder (codec), an audio player, a digital camera, a video camera, a video codec, a video player, and so forth.

The host processor 102 may be coupled to a power supply 118 configured to supply and manage power to the elements of device 100. In various embodiments, the power supply 118 may be implemented by a rechargeable battery, such as a removable and rechargeable lithium ion battery to provide direct current (DC) power, and/or an alternating current (AC) adapter to draw power from a standard AC main power supply.

As mentioned above, the radio processor 104 may perform voice and/or data communication operations for device 100. For example, the radio processor 104 may be configured to communicate voice information and/or data information over one or more assigned frequency bands of a wireless communication channel. In various embodiments, the radio processor 104 may be implemented as a communications processor using any suitable processor or logic device, such as a modem processor or baseband processor. Although some embodiments may be described with the radio processor 104 implemented as a modem processor or baseband processor by way of example, it may be appreciated that the embodiments are not limited in this context. For example, the radio processor 104 may comprise, or be implemented as, a digital signal processor (DSP), media access control (MAC) processor, or any other type of communications processor in accordance with the described embodiments. Radio processor 104 may be any of a plurality of modems manufactured by Qualcomm, Inc. or other manufacturers.

Device 100 may comprise a transceiver 120 coupled to the radio processor 104. The transceiver 120 may comprise one or more transceivers configured to communicate using different types of protocols, communication ranges, operating power requirements, RF sub-bands, information types (e.g., voice or data), use scenarios, applications, and so forth.

The transceiver 120 may be implemented using one or more chips as desired for a given implementation. Although the transceiver 120 may be shown as being separate from and external to the radio processor 104 for purposes of illustration, in various embodiments some portion or the entire transceiver 120 may be included on the same integrated circuit as the radio processor 104.

Device 100 may comprise an antenna system 122 for transmitting and/or receiving electrical signals. As shown, the antenna system 122 may be coupled to the radio processor 104 through the transceiver 120. The antenna system 122 may comprise or be implemented as one or more internal antennas and/or external antennas.

Device 100 may comprise a memory 124 coupled to the radio processor 104. The memory 124 may be implemented using one or more types of machine-readable or computer-readable media capable of storing data such as volatile memory or non-volatile memory, removable or non-removable memory, erasable or non-erasable memory, writeable or re-writeable memory, etc. The memory 124 may comprise, for example, flash memory and secure digital (SD) RAM. Although the memory 124 may be shown as being separate from and external to the radio processor 104 for purposes of illustration, in various embodiments some portion or the entire memory 124 may be included on the same integrated circuit as the radio processor 104.

Device 100 may comprise a subscriber identity module (SIM) 126 coupled to the radio processor 104. The SIM 126 may comprise, for example, a removable or non-removable smart card configured to encrypt voice and data transmissions and to store user-specific data for allowing a voice or data communications network to identify and authenticate the user. The SIM 126 also may store data such as personal settings specific to the user.

Device 100 may comprise an I/O interface 128 coupled to the radio processor 104. The I/O interface 128 may comprise one or more I/O devices to enable wired (e.g., serial, cable, etc.) and/or wireless (e.g., WiFi, short range, etc.) communication between device 100 and one or more external computer systems.

In various embodiments, device 100 may comprise location or position determination capabilities. Device 100 may employ one or more location determination techniques including, for example, Global Positioning System (GPS) techniques, Cell Global Identity (CGI) techniques, CGI including timing advance (TA) techniques, Enhanced Forward Link Trilateration (EFLT) techniques, Time Difference of Arrival (TDOA) techniques, Angle of Arrival (AOA) techniques, Advanced Forward Link Trilateration (AFTL) techniques, Observed Time Difference of Arrival (OTDOA), Enhanced Observed Time Difference (EOTD) techniques, Assisted GPS (AGPS) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), etc.

Device 100 may be configured to operate in one or more location determination modes including, for example, a standalone mode, a mobile station (MS) assisted mode, and/or a MS-based mode. In a standalone mode, such as a standalone GPS mode, device 100 may be configured to determine its position without receiving wireless navigation data from the network, though it may receive certain types of position assist data, such as almanac, ephemeris, and coarse data. In a standalone mode, device 100 may comprise a local position determination circuit 134 (e.g., a GPS receiver) which may be integrated within housing 11 (FIG. 1) configured to receive satellite data via an antenna 135 and to calculate a position fix. Local position determination circuit may alternatively comprise a GPS receiver in a second housing separate from housing 11 but in the vicinity of device 100 and configured to communicate with device 100 wirelessly (e.g., via a PAN, such as Bluetooth). When operating in an MS-assisted mode or an MS-based mode, however, device 100 may be configured to communicate over a radio access network 130 (e.g., UMTS radio access network) with a remote computer 132 (e.g., a location determination entity (PDE), a location proxy server (LPS) and/or a mobile positioning center (MPC), etc.).

In an MS-assisted mode, such as an MS-assisted AGPS mode, the remote computer 132 may be configured to determine the position of the mobile computing device and provide wireless data comprising a position fix. In an MS-based mode, such as an MS-based AGPS mode, device 100 may be configured to determine its position using acquisition data or other wireless data from the remote computer 132. The acquisition data may be provided periodically. In various implementations, device 100 and the remote computer 132 may be configured to communicate according to a suitable MS-PDE protocol (e.g., MS-LPS or MS-MPC protocol) such as the TIA/EIA standard IS-801 message protocol for MS-assisted and MS-based sessions in a CDMA radiotelephone system.

When assisting the mobile computing device 100, the remote computer 132 may handle various processing operations and also may provide information to aid location determination. Examples of position assist data may include satellite-based measurements, terrestrial-based measurements, and/or system-based measurements such as satellite almanac information, GPS code phase measurements, ionospheric data, ephemeris data, time correction information, altitude estimates, timing offsets, forward/reverse link calibration, coarse data, and so forth.

In various implementations, the position assist data provided by the remote computer 132 may improve the speed of satellite acquisition and the probability of a position fix by concentrating the search for a GPS signal and/or may improve the accuracy of location determination. Each position fix or series of position fixes may be available at device 100 and/or at the remote computer 132 depending on the location determination mode. In some cases, data calls may be made and position assist data may be sent to device 100 from the remote computer 132 for every position fix (e.g., in an ad hoc mode). In other cases, data calls may be made and position assist data may be sent periodically and/or as needed.

In various embodiments, device 100 may comprise dedicated hardware circuits or structures, or a combination of dedicated hardware and associated software, to support location determination. For example, the transceiver 120 and the antenna system 122 may comprise GPS receiver or transceiver hardware and one or more associated antennas coupled to the radio processor 104 to support location determination.

The host processor 102 may comprise and/or implement at least one LBS (location-based service) application. In general, the LBS application may comprise any type of client application executed by the host processor 102, such as a GPS application, configured to communicate location requests (e.g., requests for position fixes) and location responses. Examples of LBS applications include, without limitation, wireless 911 emergency services, roadside assistance, asset tracking, fleet management, friends and family locator services, dating services, and navigation services which may provide the user with maps, directions, routing, traffic updates, mass transmit schedules, information regarding local points-of-interest (POI) such as restaurants, hotels, landmarks, and entertainment venues, and other types of LBS services in accordance with the described embodiments.

The LBS application may be configured to send a location request in response to receiving input from device 100 or from a source external to device 100. For example, the user of device 100 may interact with a data input device to command the LBS application to send a location request. The LBS application also may send a location request in response to receiving input from an external network element or computing device that is attempting to locate the user of device 100. In some cases, the LBS application also may be configured to automatically, periodically, and/or autonomously send location requests.

Although other applications may operate without regard to the location of device 100, in various embodiments, the LBS application may request and receive position information to enhance the functionality of one or more of the other applications. For example, position information may be provided in conjunction with a messaging application to locate the sender or recipient of a message. Position information may be provided to a web browser application to generate directions to a location associated with a particular website. Positioning information may be provided to a personal management application to generate location-based alerts and/or directions to a meeting place.

Radio processor 104 may be configured to invoke a position fix by configuring a position engine and requesting a position fix. For example, a position engine interface on radio processor 104 may set configuration parameters that control the location determination process. Examples of configuration parameters may include, without limitation, location determination mode (e.g., standalone, MS-assisted, MS-based), actual or estimated number of position fixes (e.g., single position fix, series of position fixes, request position assist data without a position fix), time interval between position fixes, Quality of Service (QoS) values, optimization parameters (e.g., optimized for speed, accuracy, or payload), PDE address (e.g., IP address and port number of LPS or MPC), etc.

The radio processor 104 may comprise or implement a position engine such as a GPS engine. In various embodiments, the position engine may be configured to provide location determination capabilities for device 100. In some embodiments, the position engine may be implemented as software operating in conjunction with hardware (e.g., GPS receiver hardware) allowing device 100 to receive and process GPS satellites signals for location determination. In one embodiment, the position engine may be implemented as a QUALCOMM® gpsOne® engine.

In various implementations, the position engine may employ one or more location determination techniques such as GPS, CGI, CGI+TA, EFLT, TDOA, AOA, AFTL, OTDOA, EOTD, AGPS, GPS/AGPS, hybrid techniques, and so forth. The position engine also may be configured to operate in one or more location determination modes including a standalone mode, an MS-assisted mode, and an MS-based mode. The determined position information generated and/or obtained by the position engine generally may comprise any type of information associated with the location of device 100. Examples of position information may include, without limitation, current location, latitude, longitude, altitude, heading information, vector information such as horizontal and vertical velocity, sector-based position location, position fix information, position uncertainty, device orientation, and so forth.

Device 100 may further comprise an altimeter 140 coupled to radio processor 104 and/or host processor 102. Altimeter 140 may be a pressure altimeter or radar altimeter, and may be a digital or analog altimeter. Altimeter 140 may be a type used with handheld GPS devices, such as the Garmin eTrex series or Rino series or the Magellan eXplorist series (e.g., eXplorist 300). Altimeter 140 is configured to measure an altitude of device 100 and send a signal indicative of the measured altitude to processing circuit 101. Altitude data may be provided by a digital altimeter, gyroscope, GPS, cellular network, or other devices.

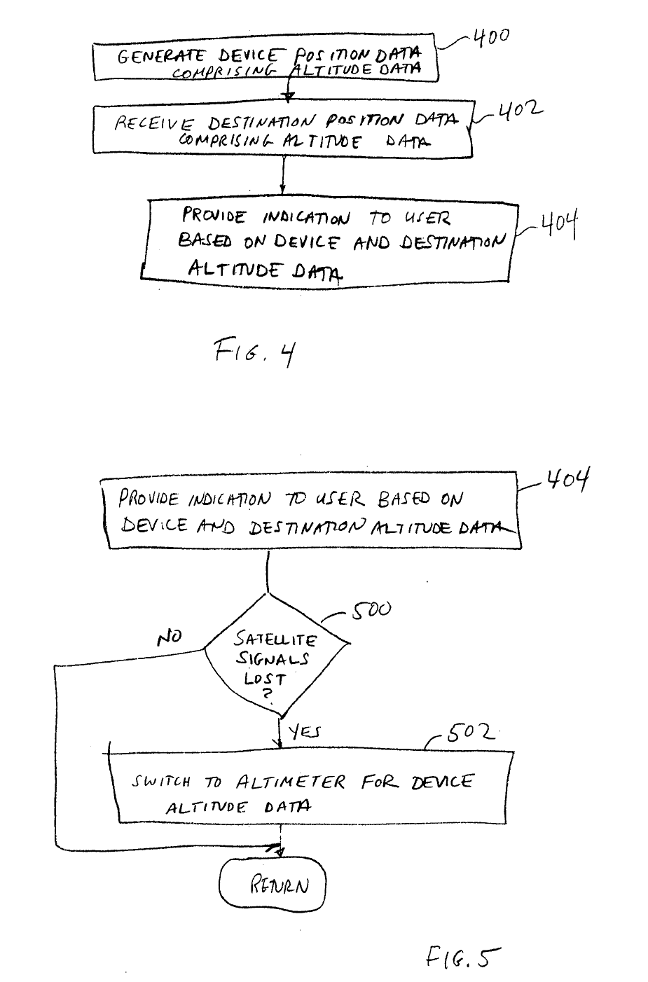

Referring now to FIG. 4, an exemplary system and method for a location based service using altitude data is shown. At step 400, position determination circuit 134 is configured to generate device position data comprising device latitude, longitude and/or altitude data. As mentioned, position determination circuit 134 may comprise a global positioning system receiver configured to generate the device position data based on signals from satellites. Position determination circuit 134 may alternatively, or in addition, be configured to receive or generate device position data using signals from a remote server, such as remote computer 132 via transceiver 120 (e.g., a cellular transceiver). Position determination circuit 134 may comprise altimeter 140 configured to generate the device altitude data.

Referring now to step 402, processing circuit 101 is configured to receive destination position data for a destination, which may comprise latitude, longitude, and/or altitude data. A destination or waypoint may be any of a point of interest (POI), a road or roadway, a city, a building, a double-deck street, an intersection, or any other position or geographic location. Destination position data may be stored in a database, such as a geographic information system database or other memory, and may be stored locally on device 100 in memory 108 and/or memory 124, and/or may be stored in whole or in part on remote computer 132 or another computer. The database may further be stored on a memory card which is removable from device 100, such as a secure digital card, mini SD card, or other removable memory device.

Device position data and destination or waypoint position data may be provided in any number of dimensions. For example, a single dimension of altitude data may be provided, two dimensions of latitude and longitude data may be provided. Further, three-dimensional data, comprising latitude, longitude and altitude may also be stored in the database and/or calculated by a source of position data for device 100, such as position determination circuit 134 and/or altimeter 140.

Referring now to step 404, device 100 is configured to provide an indication to a user based on the device altitude data and destination altitude data. The indication can be audible and/or visible.

Referring to FIG. 5, position determination circuit 134 may be configured to detect the unavailability of satellite data (step 500) and to switch from generating altitude data based on signals from satellites to generating altitude data based on altimeter 140 (step 502). For example, as mobile computing device 100 is carried by a user during use, moving through a geographic region, device 100 may be carried to or driven in a vehicle into a parking structure or building which blocks some or all satellites signals necessary for position determination having sufficient degrees of dimensions. Device 100 may be configured to detect this condition or other predetermined conditions (e.g., user input, device position, waypoint position, etc.) and to switch from generating altitude data based on satellite signals to using signals from altimeter 140. As a further alternative, device 100 may switch from generating altitude data based on satellite signals to calculating or determining device position data based on signals from a cellular network.

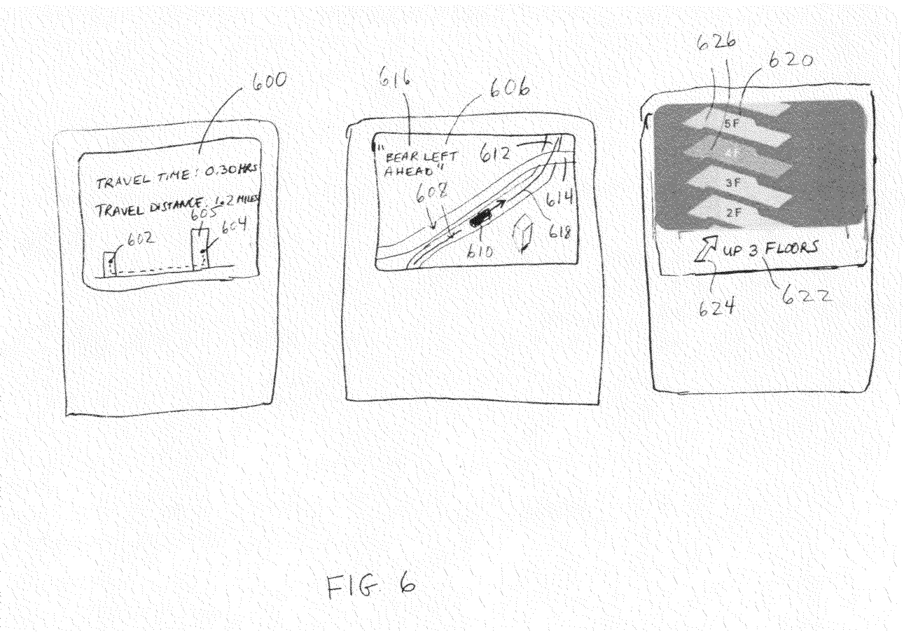

FIG. 6 discloses some exemplary indications or output data that can be provided to the user based on the device altitude data and destination altitude data. Indication 600 may comprise a travel time estimated between a current position 602 and a destination position 604, wherein the device position comprises altitude data and the destination position 604 also comprises altitude data which is taken into consideration in the indication of travel time from current position 602 to destination position 604. Current position 602 may alternatively be a starting position or other device position. The indication may further comprise a travel distance which also may be based on and take into consideration altitude data of the current position 602 and destination position 604. The time, distance, or other indications may be calculated using known algorithms, such as navigation software, such as TomTom Navigator 6 software and maps, manufactured by TomTom International BV, based in Amsterdam, The Netherlands. Indication 600 may represent a destination building 605 and a destination position 604 within the building in this exemplary embodiment.

Indication 606 provides another exemplary indication which may be provided to a user. Processing circuit 101 may be configured to determine whether device 100 is on a first or second roadway of a layered roadway. Indication 606 comprises a double-deck or layered roadway 608 comprising a first roadway having at least one same latitude and longitude coordinate as a second roadway, but different altitude coordinates. Indication 606 comprises a vehicle icon 610 showing a current device position calculated using any of the position determination systems or methods disclosed hereinabove. According to one advantageous aspect, indication 606 is configured to illustrate to a user the fact that device 100 is on the lower roadway of the layered or double-deck roadway. Device 100 may further be configured to calculate turn-by-turn navigation or other directions to a destination based on knowing that device 100 is on the lower roadway. For example, the algorithm on device 100 is configured to identify that roadway 612 will be reached instead of roadway 614 by the vehicle or device associated with icon 610 and device 100 may configured to calculate or update directions or other navigation instructions based on this determination. For example, navigation direction 616 indicates “bear left ahead” to direct a user of device 100 to bear left (onto roadway 612) instead of to bear right (onto roadway 614).

According to one exemplary embodiment, direction 616 is a step-by-step or turn-by-turn direction to a destination as calculated by device 100 using navigation algorithms. Indication 606 may further provide an indication of a current position of a vehicle or device associated with icon 610 along a predetermined route 618.

Referring to indication 620, this indication is configured to indicate to a user that the next navigation direction or step is to ascend three floors, as indicated by direction 622, which states “up three floors” and further provides an arrow 624 indicating to a user that the next directional step is to ascend from a ground floor up to a higher floor. Indication 620 may further be configured to provide maps 626 of each floor in a particular building, and may further provide detailed information regarding offices, departments, or other office sub-units located on each floor.

According to one exemplary embodiment, device 100 may access a first database to calculate a route or directions from a first current position to a destination or waypoint position. The destination or waypoint comprises an office building or other waypoint having an altitude, such as a mountain, boat, or other landmark. Upon arriving within a short range of the destination, transceiver 120 may be configured to receive additional destination or waypoint position data wirelessly from a remote computer on site at the waypoint via a cellular network or other wireless communication link. The additional or supplemental destination data may be used to provide more detailed position data regarding the location and various further waypoints or destinations available by ascending or descending in altitude at the waypoint. For example, an office or a department store may be configured to download supplemental position data indicating departments available on various floors, shops available on different floors of a mall, etc. A department store owner may work with a service provider (e.g., wireless carrier) to transmit or push data to device 100 based on pre-stored user profile data associated with a user of device 100. The transmitted data can comprise a floor of a building offering a sale and device 100 can be configured to provide directions to the floor and section of the floor having the sale. Further, a user's profile data can be used to direct a user to a section on a floor meeting a user's interests, such as directing a golf fan to the golf section on a floor.

As mentioned, output data provided to a user may comprise a distance and/or time from a device position, whether it be a current or starting point, to a waypoint position which is calculated based, at least in part, on the device altitude data and waypoint altitude data. Output may comprise other audible and/or visible data provided from device 100 to a user or to another computing device.

According to one exemplary embodiment, a current device position, starting device position, waypoint, destination position, or other position information, whether calculated or stored in a database, may be linked or associated with three-dimensional position data, comprising X (longitude), Y (latitude), and Z (altitude) data. In this way, altitude information may be added to a navigation system.

According to one exemplary embodiment, device 100 may be configured to direct a user by providing an indication or output data to an emergency exit in a building, such as a high-rise building. For example, during an emergency, a wireless signal may be sent from a building security system or other remote computer system to device 100 indicating that an emergency exists and may further provide data to direct device 100 from a current position to an emergency exit from the building. Device 100 may be configured to receive the data and display it or calculate a best route to exit the building based on current position (e.g., received via cellular network or GPS if available) and to exit the building.

According to another exemplary embodiment, a time to reach destination position from a current position of device 100 may be calculated and may further take into consideration and be calculated based on the need to travel in the Z direction, whether it be up or down to get out of a building or parking structure at a starting position and likewise to get up or down to a particular floor or altitude at the destination. Device 100 may be configured to calculate a time difference between taking an elevator or stairs and provide an indication of the travel times for each path or indicate an optimal path based on predetermined criteria.

According to the embodiment of FIG. 5, device 100 may be configured to switch from receiving altitude from GPS satellites to an altimeter or cellular network upon detecting the loss of satellites, or upon detecting the device being at a current position of a building and about to enter the building, being just outside the building, or having entered a building. The switch can be done manually by way of prompting a user to confirm the switch or automatically, autonomously, or without user input.

According to one exemplary embodiment, device 100 may be integrated into a vehicle navigation system and provide indications and/or output data via a display integrated into the vehicle.

According to another exemplary embodiment, a starting position or current position of device 100 may be on one floor of a building and device 100 may be configured to calculate turn-by-turn or step-by-step directions to assist a user in navigating from the current floor to a different floor in a building. Device 100 may be configured to provide an indication of an estimated time of arrival, distance, number of stairs, number of elevator rides, and further may be configured to calculate a route from one floor to another floor in a building or from one altitude to another altitude in another location (e.g., a hiking trail) and may be configured to provide a fastest route or route having fewest stairways or fewest elevators, or a route having waypoints to be stopped at between a current position on a floor and a destination position on another floor.

According to one embodiment, device 100 is configured to provide a user interface to receive a destination from a user (e.g., an address, point of interest, etc.). Device 100 may be configured to determine if the destination comprises altitude-specific data (e.g., if destination is multi-story). If so, the user interface requests which floor or section of a floor is the destination within the destination. Directions are then provided to the user. The directions or other indication can be calculated or generated based on actual altitude data or approximate altitude data (e.g., assuming a floor height of X meters would be Y floor, etc.).

With reference to the disclosure and claims, use of the phrase “based on” means “based in least in part on,” and use of the term “a” or “an” means “one or more” or “at least one.” Further, any of the steps of any of the methods disclosed herein may be combined with any of the other steps and/or rearranged with other steps in alternative embodiments. Specifically, various embodiments may make use of different combinations of parts or all of the methods disclosed herein.

While the exemplary embodiments illustrated in the Figs., and described above are presently exemplary, it should be understood that these embodiments are offered by way of example only. Accordingly, the present invention is not limited to a particular embodiment, but extends to various modifications that nevertheless fall within the scope of the appended claims.

What is claimed is:

1. A mobile computing device, comprising:
a housing configured to be carried by a user while in use;
a position determination circuit configured to generate device position data comprising device altitude data; and
a processing circuit configured to receive destination position data for a destination, the destination position data comprising destination altitude data, and to provide an indication to a user based on the device altitude data and destination altitude data.

2. The mobile computing device of claim 1, further comprising mobile telephony circuitry configured for mobile telephony communications.

3. The mobile computing device of claim 1, wherein the position determination circuit comprises a global positioning system receiver configured to generate the device altitude data based on signals from satellites.

4. The mobile computing device of claim 3, wherein the position determination circuit is configured to detect the unavailability of satellites and to switch from generating altitude data based on signals from satellites to generating altitude data based on an altimeter coupled to the mobile computing device.

5. The mobile computing device of claim 1, wherein the position determination circuit is configured to receive the device altitude data from a remote server via a cellular transceiver.

6. The mobile computing device of claim 1, wherein the position determination circuit comprises an altimeter configured to generate the device altitude data.

7. The mobile computing device of claim 1, wherein the destination position data comprises a destination building and a destination position within the building.

8. The mobile computing device of claim 1, wherein the destination position data comprises a destination roadway which is one roadway of a layered roadway.

9. The mobile computing device of claim 1, wherein the indication comprises directions to the destination.

10. The mobile computing device of claim 9, wherein the directions comprise step-by-step directions to the destination.

11. The mobile computing device of claim 9, wherein the directions comprise an estimated time of travel to the destination.

12. The mobile computing device of claim 9, wherein the directions comprises directions from a current device altitude to a destination altitude.

13. The mobile computing device of claim 1, wherein the indication comprises a current position along a predetermined route.

14. The mobile computing device of claim 1, further comprising a wireless transceiver, wherein the processing circuit is configured to receive the destination position data from a remote computer via the wireless transceiver.

15. A mobile computing device, comprising:
a position determination circuit configured to generate device position data comprising latitude, longitude and altitude data for the device; and
a processing circuit configured to receive waypoint position data from a database of waypoint data, the waypoint position data comprising latitude, longitude and altitude data, and to provide output data to a user based on the device altitude data and waypoint altitude data.

16. The mobile computing device of claim 15, wherein the processing circuit is configured to determine whether the device is on a first or a second roadway of a layered roadway.

17. The mobile computing device of claim 15, wherein the output data comprises a distance or time from a device position to a waypoint position which is calculated based at least in part on the device altitude data and waypoint altitude data.

18. The mobile computing device of claim 15, further comprising a telephony transceiver configured for telephony communication and an operating system configured to store personal information management applications and to synchronize personal information management data with a remote server.

19. A navigation system, comprising:
a database of waypoints, each waypoint comprising three-dimensional position data;
a source of position data configured to provide three-dimensional position data for the navigation system as it moves through a geographic region;
a display; and
a processing circuit configured to receive the three-dimensional position data for the waypoint and the three-dimensional position data for the navigation system, to use the three-dimensional waypoint and position data to generate navigation data and to display the navigation data on the display.

20. The navigation system of claim 19, wherein the navigation system comprises a smartphone.
